(19) United States
(12) Patent Application Publication
(10) Pub. No.: US 2006/0047414 A1
(43) Pub. Date: Mar. 2, 2006

(54) Probe-car system using beacon and apparatus therefore

(75) Inventor: Shinya Adachi, Yokohama-shi (JP)

Correspondence Address: PEARNE & GORDON LLP, 1801 EAST 9TH STREET, SUITE 1200, CLEVELAND, OH, 44114-3108, US

(73) Assignee: Matsushita Electric Industrial Co., Ltd.

(21) Appl. No.: 10/932,435

(22) Filed: Sep. 2, 2004

(51) Int. Cl. G01C 21/26

(52) U.S. Cl. 701/201; 701/207

(57) ABSTRACT

The present invention provides a probe-car system in which beacons are used to efficiently collect measurement data from an FCD on-vehicle apparatus. There are provided an on-board unit of a probe-car 121 which selects one of second information (1) of measurement information measured during running and road section reference data indicating a measurement section of the measurement information and first information (3) of the measurement information, and uploads it to a beacon 123, and a center apparatus which collects the measurement information from the on-board unit of a probe-car 121 through the beacon 123. In this system, when the probe-car 121 runs along an installation route of beacons 122 and 123 and passes through under the downstream side beacon 123, only the measurement information is transmitted, so that the data amount of the measurement information can be increased, and the detailed measurement information can be transmitted. When the probe-car 121 runs along a bypass, the swept path of the bypass and the measurement information are uploaded to the downstream side beacon 123, so that the center apparatus can utilize it as the measurement information of the bypass.

### BACKGROUND OF THE INVENTION

1. Field of the Invention

The present invention relates to a probe-car system which collects measurement data measured while a car is moving and utilizes it for traffic information and an apparatus therefore, and particularly to a probe-car system which enables measurement data to be efficiently collected through a beacon and an apparatus therefore.

2. Description of the Related Art

In recent years, an investigation has been made on the introduction of a probe-car system (also called a floating car data (FCD) system) using a running vehicle as a sensor (probe) for collecting traffic information. In this system, an FCD on-vehicle apparatus installed in a vehicle records the speed of the vehicle and the swept path thereof, and transmits them to a center. In the center, measurement data transmitted from respective vehicles are analyzed to create road traffic information relating to traffic flow and the like.

Patent document 1 (JP-A-2002-269669) discloses a probe-car system in which a center specifies a collection area of FCD, an FCD on-vehicle apparatus of a vehicle running in this area measures and stores a running position, a running speed and the like at every unit time, and the stored measurement data is transmitted to the center by using a cellular phone at every regular time period.

However, in the probe-car system using the cellular phone, it becomes a serious problem who bears the communication cost. In the case where the center bears the communication cost, the cooperation of the FCD on-vehicle apparatus side is easily obtained, and it is expected that a large amount of measurement data are collected. However, the burden of the center becomes severe. On the other hand, when the FCD on-vehicle apparatus side is forced to bear the communication cost, it becomes difficult to collect a large amount of data.

### SUMMARY OF THE INVENTION

The invention solves the conventional problem as stated above, and an object thereof is to provide a probe-car system in which beacons used for providing traffic information are utilized to efficiently collect measurement data from an FCD on-vehicle apparatus, and an apparatus for constructing the system.

A probe-car system of the invention includes an on-board unit of a probe-car which selects one of second information of measurement information measured during running and road section reference data indicating a measurement section of the measurement information and first information of the measurement information, and uploads it to a beacon, and a center apparatus which collects the measurement information from the on-board unit of a probe-car through the beacon.

Besides, an on-board unit of a probe-car of the invention includes a communication unit for communicating with a beacon, an own vehicle position judgment unit for detecting own vehicle position, a sensor information collection unit for collecting measurement information of a sensor, a storage unit for storing the measurement information collected by the sensor information collection unit and a swept path made of a set of the own vehicle position detected by the own position judgment unit, a coding processing unit for transforming the measurement information and the swept path stored in the storage unit into coded data, an information transmission unit for transmitting the coded data of the one of the second information including the measurement information and the swept path and the first information the measurement information, to the beacon, when passing through the beacon, and an instruction information reception unit for receiving instruction information including instructions of a measurement method of the measurement information and a coding method of the coded data from the beacon.

In this system, when the probe-car runs along an installation route of beacons and passes through under a downstream side beacon, only the measurement information is uploaded, so that the data amount of the measurement information can be increased, and the detailed measurement information can be transmitted. When the probe-car runs along a bypass and passes through under a downstream side beacon, the swept path of the bypass and the measurement information are uploaded, so that the center apparatus can utilize it as the measurement information of the bypass.

### BRIEF DESCRIPTION OF THE DRAWINGS

FIG. 1 is a view showing a data structure of transmitted/received data in a probe-car system according to a first embodiment of the invention;

FIG. 2 is a block diagram showing a structure of the probe-car system according to the first embodiment of the invention;

FIG. 3 is a flow chart showing an operation of the probe-car system according to the first embodiment of the invention;

FIG. 4 is a view showing a relation between original data and a first order scaling coefficient;

FIG. 5 is a view showing a relation among first order, second order and third order scaling coefficients;

FIG. 6 is a view showing general expressions of wavelet transform;

FIGS. 7A and 7B are views showing filter circuits for realizing DWT;

FIG. 8A is a view showing separation of a signal in DWT and FIG. 8B is a view showing reconstruction of signals in IDWT;

FIGS. 9A and 9B are views showing filter circuits realizing the DWT and the IDWT in the first embodiment of the invention;

FIGS. 10A to 10C are explanatory views of road section reference data;

FIG. 11 is a view showing a data structure of transmitted/received data in a probe-car system according to a second embodiment of the invention;

FIG. 12 is a block diagram showing a structure of the probe-car system according to the second embodiment of the invention;

FIG. 13 is a flow chart showing an operation of the probe-car system according to the second embodiment of the invention;

FIG. 14 is a view showing a data structure of transmitted/received data in a probe-car system according to a third embodiment of the invention; and

FIG. 15 is a flow chart showing an operation of the probe-car system according to the third embodiment of the invention.

In the drawings, a reference numeral 80 refers to a center apparatus; 81 to a swept path measurement information utilization part; 82 to a coded data decoding part; 83 to a FCD information reception part; 84 to a measurement coding instruction transmission part; 85 to a measurement coding instruction selection part; 86 to a measurement coding instruction data; 87 to a beacon communication part; 90 to an on-board unit of a probe-car; 91 to a FCD information transmission part; 92 to a FCD information selection part; 93 to a coding processing part; 94 to a measurement coding instruction reception part; 95 to a measurement coding instruction data; 96 to a default measurement coding instruction data; 97 to an own vehicle position judgment part; 98 to a swept path measurement information storage part; 99 to a sensor information collection part; 100 to an on-vehicle apparatus communication part; 101 to a GPS antenna;102 to a gyro; 106 to a sensor A; 107 to a sensor B; 108 to a sensor C; 121 to a probe-car; 122 to an upstream side beacon; 123 to a downstream side beacon; 181 to a low-pass filter; 182 to a high-pass filter; 183 to a thinning circuit; 184 to a low-pass filter; 185 to a high-pass filter; 186 to a thinning circuit; 187 to an adder circuit; 191 to a filter circuit; 192 to a filter circuit; and 193 to a filter circuit.

### DETAILED DESCRIPTION OF THE PREFERRED EMBODIMENTS

In a probe-car system of an embodiment of the invention, measurement information measured by a probe-car is collected through a beacon.

At present, beacons are installed on a road in order to provide VICS road traffic information to a passing vehicle at a pinpoint. The beacons have two types, that is, an optical beacon for a general road and a radio beacon for an expressway. For example, in the case of the optical beacon, two-way communication with an on-vehicle apparatus can be performed at a data transfer speed of 1 Mbps. Although a distance between beacons varies according to an installation state or the like, it is about several hundred m to several Km.

### First Embodiment

In a probe-car system of a first embodiment of the invention, a swept path and measurement information of speed, fuel consumption and the like are measured by a probe-car, and when the probe-car first passes through under a beacon, or passes through under a next beacon after a specified time has passed since the probe-car passed through under the last beacon (or after running a specified distance or more), the measurement information and the swept path data are uploaded as FCD information from an on-board unit of a probe-car through the beacon. The swept path data has a meaning as road section reference data indicating an object road section of the measurement information.

A center apparatus having received the FCD information specifies the object road section of the measurement information from the swept path data, and utilizes the measurement information for the creation of traffic information of the object road section.

When the probe-car passes through under the next beacon within the specified time since it passed through under the last beacon (or before it runs the specified distance), the travel distance and the number of the last passed beacon, together with the measurement information, are uploaded as the road section reference data from the on-board unit of a probe-car.

The center apparatus having received the FCD information regards the probe-car as having run along the installation route of the beacons in a case where the travel distance and the installation distance between the beacons are substantially coincident with each other, and utilizes the measurement information for the creation of the traffic information of the route. On the other hand, in the case where the travel distance and the installation distance between the beacons are much different from each other, the center apparatus regards the probe-car as having run along a bypass, and stops the use of the measurement information.

Respective processings will be described in detail.

<Creation of Running Locus Data>

Position data at every regular distance L (for example, 200 m) is sampled from the position data measured by the probe-car during running, the position data at the respective sampling points (nodes) are arranged in sequence, and the node row is made the swept path data and is transmitted to the center apparatus. At this time, in order to decrease the data amount of the swept path data, a following processing is performed.

First, the position data of a sampling point (node) is expressed by an argument 0 from an adjacent node. When a measurement start point or an end point is made a reference point, and the position of the reference point is specified by latitude and longitude, and when L is made constant, the position of each node can be specified by only the argument θ. Next, the position data is transformed into data having a bias statistically. For that purpose, when an argument from an adjacent node of a noticed node is made θⱼ, the position data of the node is expressed by a difference between an argument predicted value of the node predicted by using arguments θⱼ₋₁ and θⱼ₋₂ of preceding nodes (statistical predicted value: for example, (θᵢ₋₁+θⱼ₋₂)/2) and the argument θⱼ. Next, the data of the node row expressed by the argument predicted difference value is subjected to variable length coding on the basis of a code table, and the coded data is transmitted to the center apparatus through the beacon.

When receiving the swept path data, the center apparatus decodes the coded data by using the same code table, and decodes the arrangement of the position data of the nodes. Map matching of the arrangement of the nodes and the own map data is performed, and the swept path data of the probe-car is specified on the own map data.

<Creation of Measurement Information>

Also with respect to the measurement information of speed, fuel consumption and the like, coding is made in order to reduce the data amount. Here, a description will be given to a case where sampling data of the measurement information is subjected to discrete wavelet transform (DWT) to code the measurement information.

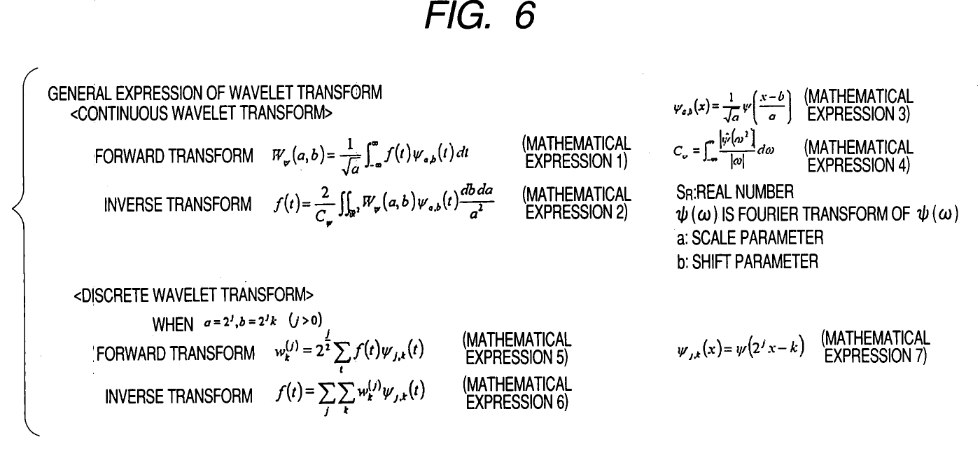

FIG. 6 shows general expressions of the wavelet transform. The wavelet is a set of functions such as (mathematical expression 3) which is formed by performing an operation (scale transform) of magnifying a function Ψ(t), which is called a basic wavelet and exists only in a limited range in time and frequency, by a factor of a on a time axis, or an operation (shift transform) of shifting it by b in time. The frequency and time components of a signal corresponding to the parameters “a” and “b” can be extracted by using this function, and this operation is call the wavelet transform.

The wavelet transform includes a continuous wavelet transform and a discrete wavelet transform (DWT). The forward transform of the continuous wavelet transform is expressed by (mathematical expression 1), and the inverse transform thereof is expressed by (mathematical expression 2). When the real numbers a and b are made a=2j and b=2jk (j>0), the forward transform of the discrete wavelet transform is expressed by (mathematical expression 5), and the inverse transform (IDWT) is expressed by (mathematical expression 6).

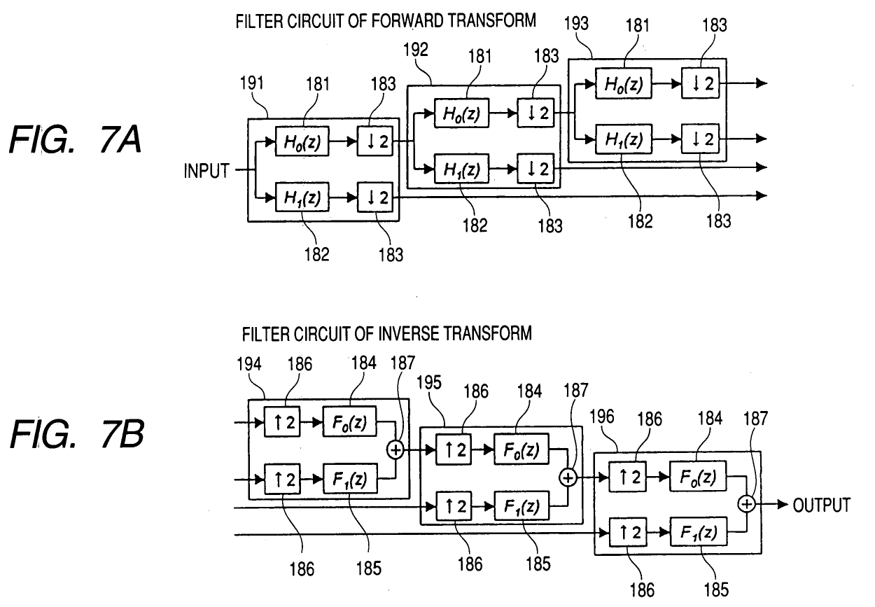

The DWT can be realized by a filter circuit for recursively dividing a low frequency, and the IDWT is realized by a filter circuit repeating synthesis inverse to the time of division. FIG. 7A shows the filter circuit of the DWT. The DWT circuit is constructed of plural cascade-connected circuits 191, 192 and 193 each including a low-pass filter 181, a high-pass filter 182, and a thinning circuit 183 for thinning out signals to ½. The high frequency component of a signal inputted to the circuit 191 passes through the high-pass filter 182, is thinned out by the thinning circuit to ½, and is outputted. The low frequency component thereof passes through the low-pass filter 181, is thinned out by the thinning circuit to ½, and is inputted to the next circuit 192. Similarly, also in the circuit 192, the high frequency component is thinned out and is outputted, and the low frequency component is thinned out, is inputted to the next circuit 193, and is similarly divided into a high frequency component and a low frequency component.

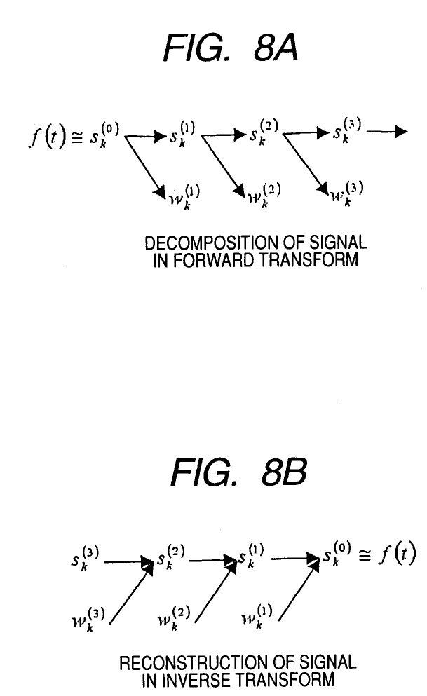

FIG. 8A shows signals decomposed by the respective circuits 191, 192 and 193 of the DWT circuit. An input signal f(t) (=Sk⁽⁰⁾; a superscript denotes the order) is divided in the circuit 191 into a signal Wk⁽¹⁾ having passed through the high-pass filter 182 and a signal Sk⁽¹⁾ having passed through the low-pass filter 181. The signal Sk⁽¹⁾ is divided in the next circuit 92 into a signal Wk⁽²⁾ having passed through the high-pass filter 182 and a signal Sk⁽²⁾ having passed through the low pass filter 181. The Sk⁽²⁾ is divided in the next circuit 193 into a signal Wk⁽³⁾ having passed through the high-pass filter 182 and a signal Sk⁽³⁾ having passed through the low-pass filter 181. The S(t) is called a scaling coefficient (or low-pass filter), and W(t) is called a wavelet coefficient (or high-pass filter).

Next (mathematical expression 8) and (mathematical expression 9) indicate transform expressions of the DWT used in the embodiment of the invention.
step 1: wt(t)=f(2t+1)−[{f(2t)+f(2t+2)}/2] (mathematical expression 8)
step 2: s(t)=f(2t)+[{w(t)+w(t−1)+2}/4] (mathematical expression 8)

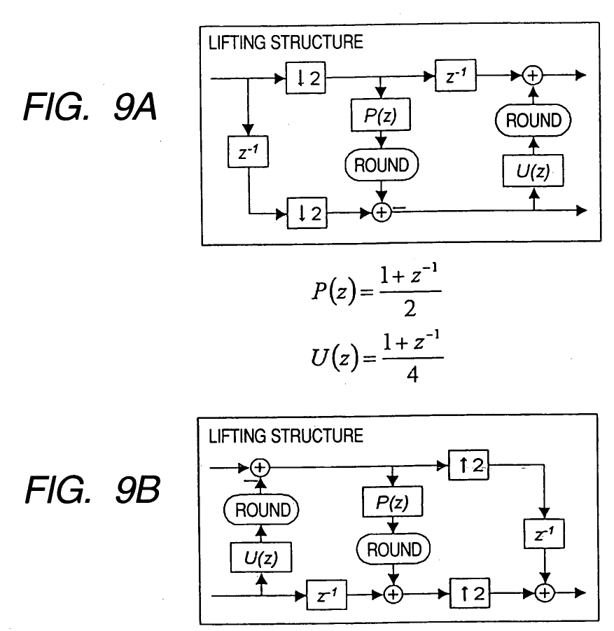

In the first order forward transform, sampling data of the measurement information is made the discrete value f(t), and is transformed by the (mathematical expression 8) and the (mathematical expression 9) into the first order wavelet coefficient and the first order scaling coefficient. In a subsequent nth order forward transform, an (n−1)th order scaling coefficient is made f(t), and transform into an nth order wavelet coefficient and nth order scaling coefficient is performed by the (mathematical expression 8) and the (mathematical expression 9). FIG. 9A shows a structure of each of the circuits 191, 192 and 193 of the DWT circuit realizing this transform. In the drawing, “Round” indicates a rounding processing. The sampling data (state amount) of a traffic state is transformed into the scaling coefficient and the wavelet coefficient by the (mathematical expression 8) and the (mathematical expression 9) and is provided.

FIG. 7B shows a filter circuit of the IDWT. The IDWT circuit is constructed of plural cascade-connected circuits 194, 195 and 196 each including an interpolation circuit 186 for interpolating a signal by a factor of 2, a low-pass filter 184, a high-pass filter 185, and an adder 187 for adding outputs of the low-pass filter 184 and the high-pass filter 185. Signals having a high frequency component and a low frequency component inputted to the circuit 194 are interpolated by a factor of 2, are added to each other, are inputted to the next circuit 195, are added with a high frequency component in this circuit 195, are further added with a high frequency component in the next circuit 195, and are outputted.

FIG. 8B shows signals reconstructed by the circuits 194, 195 and 196 of the IDWT circuit. In the circuit 194, the scaling coefficient Sk⁽³⁾ and the wavelet coefficient Wk⁽³⁾ are added to each other, so that the scaling coefficient Sk⁽²⁾ is created. In the next circuit 195, the scaling coefficient Sk⁽²⁾ and the wavelet coefficient Wk⁽²⁾ are added to each other, so that the scaling coefficient Sk⁽¹⁾ is created. In the next circuit 196, the scaling coefficient Sk⁽¹⁾ and the wavelet coefficient Wk⁽¹⁾ are added to each other, so that the Sk⁽⁰⁾ (=f(t)) is created.

Next (mathematical expression 10) and (mathematical expression 11) indicate transform expressions of the IDWT used in the embodiment of the invention.
step 1: f(2t)=s(t)+[{w(t)+w(t−1)+2}/4] (mathematical expression 10)
step 2: f(2t+1)=w(t)−[{f(2t)+f(2t+2)}/2] (mathematical expression 11)

In the nth order inverse transform, the signal f(t) transformed by (n+1)th order IDWT is made the scaling coefficient, and the transform with the steps of the (mathematical expression 10) and the (mathematical expression 11) is performed. FIG. 9B shows a structure of each of the circuits 194, 195 and 196 of the IDWT circuit for realizing this transform.

As stated above, from the sampling data of the measurement information, the scaling coefficient and the wavelet coefficient can be calculated by the (mathematical expression 8) and the (mathematical expression 9). Besides, from the scaling coefficient and the wavelet coefficient, the sampling data of the measurement information can be restored by the (mathematical expression 10) and the (mathematical expression 11).

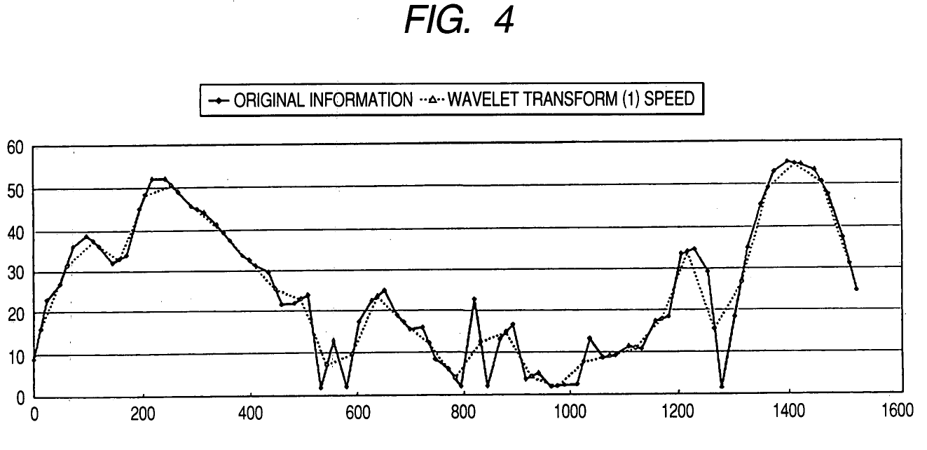

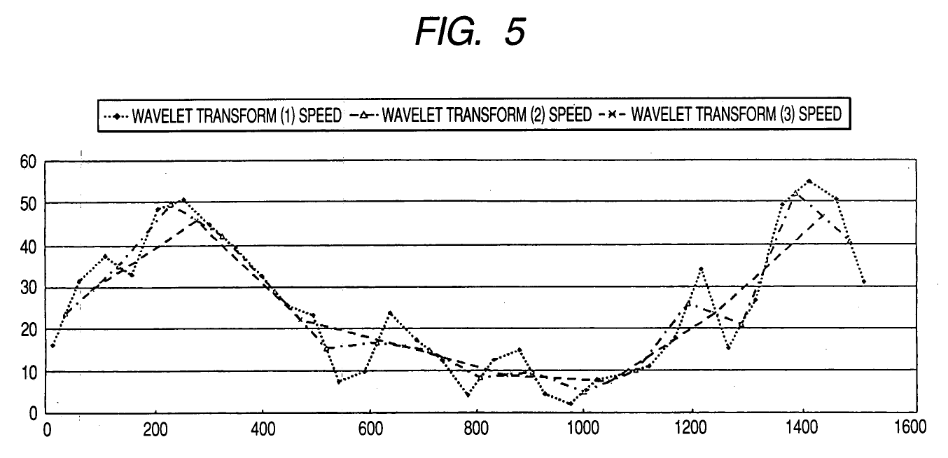

The first order scaling coefficient smoothes and indicates the shape expressed by the sampling data (original data), and the nth order scaling coefficient smoothes and indicates the shape expressed by the (n−1)th order scaling coefficient. In FIG. 4, the vertical axis indicates speed, the horizontal axis indicates distance from a reference point, the sampling data of speed measured by the probe-car is indicated by a solid line, and the first scaling coefficient obtained when the original data is subjected the DWT once is indicated by a dotted line. FIG. 5 shows the first scaling coefficient (dotted line), a second scaling coefficient (dashed line) obtained when the DWT is further repeated, and a third scaling coefficient (dotted line with long ling portions). The distance interval between the first order scaling coefficients is twice the distance interval of the original data, and the value of the scaling coefficient is an average of the values of the original data included in the distance interval. The distance interval between the nth order scaling coefficients is twice the distance interval between the (n−1)th order scaling coefficients, and the value of the nth order scaling coefficient is an average of the values of the (n−1)th order scaling coefficient included in the distance interval.

Accordingly, even in the case where the amount of data uploaded from the on-board unit of a probe-car is limited, when data capable of restoring the nth (n=1, 2, . . . ) scaling coefficient is transmitted, the center apparatus can grasp the rough state (coarse measurement information) of the measurement information. As the order of the scaling coefficient becomes high, the amount of data transmitted from the on-board unit of a probe-car is decreased, and the measurement information which can be grasped by the center apparatus becomes coarse.

<Transmitted/Received Data Structure>

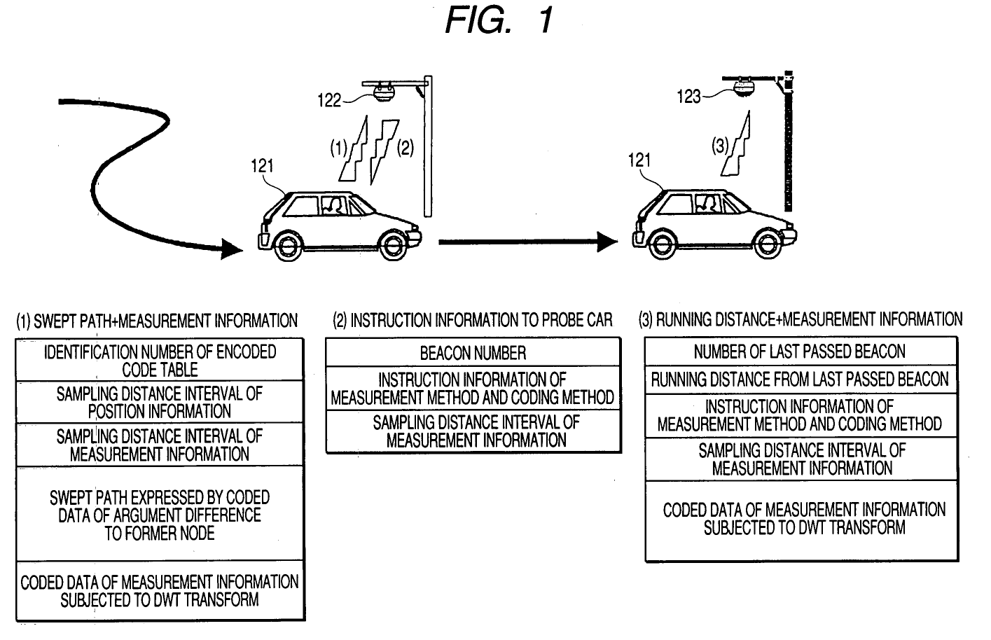

FIG. 1 exemplifies a data structure of data transmitted and received between the on-board unit of a probe-car and the beacon.

When a probe-car 121 first passes through under a beacon 122, or passes through under the beacon 122 after a specified time has passed since it passed through under the last beacon (or after it travels a specified distance), FCD information (“swept path+measurement information”) indicated by (1) is transmitted from the on-board unit of a probe-car to the beacon 122. The information includes the identification number of a code table used for encoding of swept path, sampling distance interval of position information indicating the swept path, distance interval of the measurement information, coded data indicating the swept path, and coded data of the measurement information subjected to the DWT transform.

Since the position information of the beacon 122 as the reference point (end point) of the swept path is already known in the center apparatus, it is not necessary that the position information of the reference point is included in the data indicating the swept path. Nevertheless, since the data amount of the coded data indicating the swept path is large, it is necessary to lessen the data amount of the coded data of the measurement information in the FCD information of (1). Thus, measures are taken such that only data necessary for restoring the nth order scaling coefficient is made to be included, the sampling distance interval of the measurement information is expanded to roughen the accuracy of the measurement information, or the distance of the section as the object of the measurement information is narrowed.

On the other hand, the beacon 122 downloads instruction information indicated by (2) to the on-board unit of a probe-car passing through under the beacon 122. The information includes the beacon number of the beacon 122, instruction information of the measurement method and coding method of the measurement information (information of the number of the measurement method and coding method previously transmitted to the on-board unit of a probe-car, and a code table used for coding), sampling distance interval of the measurement information, and the like.

When the probe-car 121 passes through under a downstream side beacon 123 within the specified time since it passed through under the upstream side beacon 122 (or before it runs the specified distance), FCD information (“travel distance+measurement information”) indicated by (3) is transmitted from the on-board unit of a probe-car to the beacon 123. This information includes the number of the last passed beacon 122, the travel distance from the last passed beacon 122, the instruction number of the measurement method and coding method received from the last passed beacon 122, the sampling distance interval of the measurement information, and the coded data of the measurement information subjected to the DWT transform.

Since the FCD information does not include the data of the swept path, the data amount of the coded data of the measurement information can be increased, and the information accuracy of the measurement information can be raised.

<System Structure>

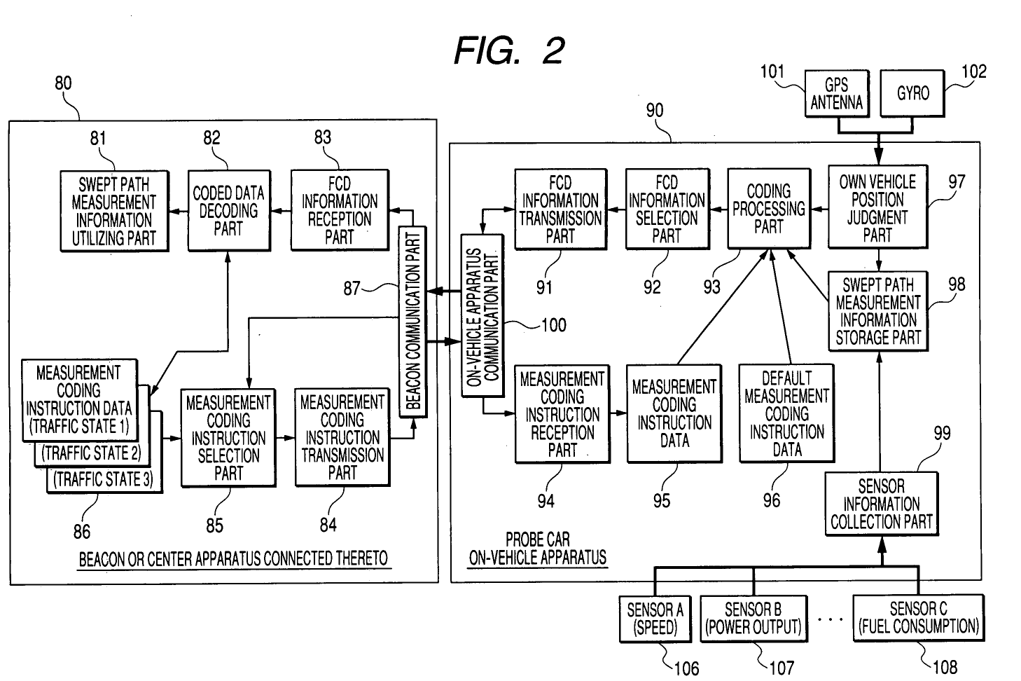

FIG. 2 shows a structure of this probe-car system. This system includes an on-board unit 90 of a probe-car, for measuring and providing data at the time of running, and a center apparatus 80 for collecting the data through a beacon. The beacon itself may have the structure of the center apparatus 80.

The on-board unit 90 includes an on-vehicle apparatus communication part 100 for performing two-way communication with the beacon, a measurement coding instruction reception part 94 for receiving instruction information from the beacon, a sensor information collection part 99 for collecting measurement information of a sensor A 106 for detecting speed, a sensor B 107 for detecting power output, a sensor C 108 for detecting fuel consumption, and the like, an own vehicle position judgment part 97 for detecting own vehicle position by using GPS information received by a GPS antenna 101 and information of a gyro 102, a swept path measurement information storage part 98 for storing the swept path of the own vehicle and the measurement information of the sensors A, B and C, a coding processing part 93 for coding the measurement information and sampling data of the swept path on the basis of instruction data 95 of the measurement method and coding method received from the beacon and instruction data 96 of the default measurement method and coding method previously held by the on-board unit 90, an FCD information selection part 92 for selecting whether the FCD information (1) of FIG. 1 is to be transmitted to the beacon or the FCD information of (3) is to be transmitted, and an FCD information transmission part 91 for transmitting the FCD information selected by the FCD information selection part 92 to the beacon when passing through under the beacon.

On the other hand, the center apparatus 80 includes a beacon communication part 87 for performing two-way communication with the on-board unit 90, an FD information reception part 83 for receiving the FCD information from the on-board unit 90, a coded data decoding part 82 for decoding the coded data included in the FCD information, a swept path measurement information utilizing part 81 for utilizing the data of the decoded measurement information and swept path, a measurement coding instruction selection part 85 for selecting measurement coding instruction data 86 to be given to the on-board unit 90, and a measurement coding instruction transmission part 84 for transmitting the selected measurement coding instruction data 86 to the on-board unit 90.

In the center apparatus 80, there are prepared the plural measurement coding instruction data 86 made to correspond to traffic states and each including the measurement method and coding method of the measurement information, the information of the code table, and the like. When the beacon communication part 87 starts the two-way communication with the on-board unit 90, the measurement coding instruction selection part 85 selects the measurement coding instruction data 86 corresponding to the present traffic state, and the selected measurement coding instruction data 86 is transmitted to the on-bard unit 90.

<Processing Flow>

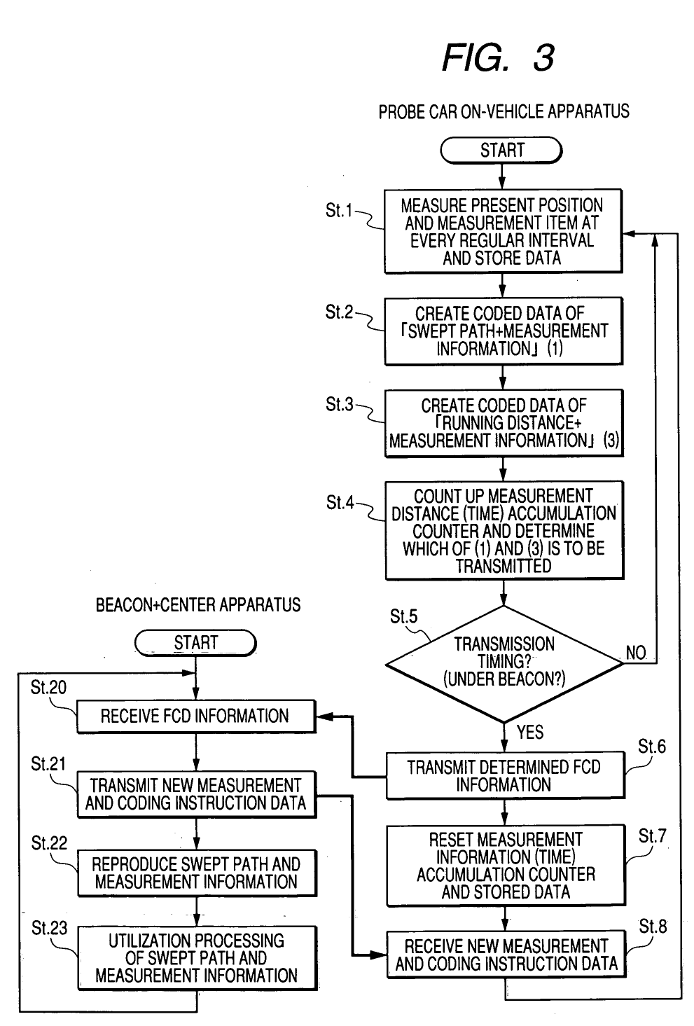

FIG. 3 shows a processing flow of the probe-car system. The on-board unit 90 measures present position and speed (measurement information) in a unit of, for example, one second, and stores the measurement data in the swept path measurement information storage part 98 (step 1). The coding processing part 93 creates sampling data of sampling distance interval of position information and creates coding data expressing the swept path from the stored swept path data in accordance with the measurement coding instruction data 95 when the instruction data has been received from the beacon, or in accordance with the default measurement coding instruction data 96 if not so. Besides, the coding processing part creates, from the stored speed information, the sampling data of sampling distance interval of the measurement information, and creates coded data of speed information subjected to the DWT transform (step 2).

Next, the coding processing part 93 creates the data of travel distance from the last passed beacon, and creates the coded data of speed information subjected to the DWT transform (step 3).

The FCD information selection part 92 counts up an accumulation counter for counting the accumulated value of distance (or time) from the last passed beacon, and when the count value of the accumulation counter exceeds a specified value, the “swept path+measurement information” ((1) of FIG. 1) created at step 2 is determined to be the transmission data. When the count value of the accumulation counter is the specified value or less, the “travel distance+measurement information” ((3) of FIG. 1) created at step 3 is determined to be the transmission data (step 4).

In the case where the on-vehicle apparatus communication part 100 starts the communication with the beacon communication part 87, the FCD information transmission part 91 judges that the timing of transmission occurs (step 5), and transmits the FCD information selected by the FCD information selection part 92 to the beacon (step 6). When the timing of transmission does not occur, the procedure from step 1 is repeated.

After transmitting the FCD information to the beacon, the on-board unit 90 resets the accumulation counter, and resets the data stored in the swept path measurement information storage part 98 (step 7).

When receiving the FCD information (step 20), the center apparatus 80 transmits the new measurement and coding instruction data 86 selected by the measurement coding instruction selection part 85 to the on-board unit 90 (step 21). The on-board unit 90 receives the new measurement coding instruction data (step 8), and repeats the procedure from step 1.

In the case where “swept path+measurement information” ((1) of FIG. 1) is received, the center apparatus 80 refers to the pertinent measurement and coding instruction data, decodes the coded data, and reproduces the measurement information on the swept path. In the case where “travel distance+measurement information” ((3) of FIG. 1) is received, the center apparatus refers to the travel distance and the beacon number included in the FCD information. When the installation interval between the upstream side beacon and the downstream side beacon is substantially coincident with the travel distance, the center apparatus refers to the pertinent measurement and coding instruction data, decodes the coded speed data, and reproduces the speed information while the installation route of beacons is made the swept path (step 22).

The center apparatus 80 utilizes the reproduced speed information for creation of the traffic information and the like (step 23).

As stated above, in the probe-car system, the FCD information can be efficiently collected from the on-board unit by using the beacon.

### MODIFIED EXAMPLE

Although the description has been given to the case where the variable length coding system of an argument predicted difference value is applied to the coding of the swept path data, and the coding system by DWT is applied to the coding of the measurement information, the invention is not limited to this. The measurement information can be coded by the variable length coding system of the argument predicted difference value, and the swept path data can be coded by the DWT. Besides, it is also possible to use orthogonal transform such as DFT (discrete Fourier transform), DCT (discrete cosine transform), DHT (discrete Hadamard transform), or DWT (discrete wavelet transform).

Besides, although the description has been given to the case where the measurement and coding instruction data is downloaded from the beacon to the on-board unit, this is not inevitable.

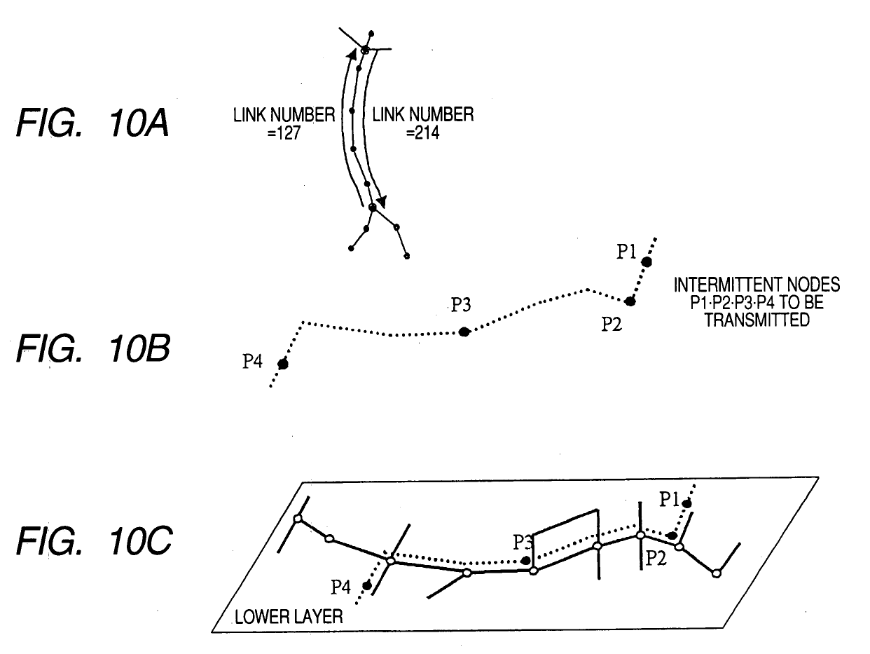

Besides, although the description has been given to the case where the swept path data is transmitted as the road section reference data indicating the object road section of the measurement information, the road section reference data may be others. For example, as shown in FIG. 10A, uniformly determined road section identifiers (link number) and intersection identifiers (node number) may be used.

In the case where both the on-board unit and the center apparatus refer to the same map, the on-board unit transmits the latitude and longitude data of the measurement start point on the map to the center apparatus, and the center apparatus can specify the road section based on this data.

Besides, as shown in FIG. 10B, the object road may be transmitted by transmitting latitude and longitude data (including the attribute information of name, kind of road and the like as well) for position reference of intermittent nodes P1, P2, P3 and P4, which are extracted from intersection parts and roads at midpoints in the link, to the center apparatus. Here, the nodes are as follows: P1=link center point, P2=intersection part, P3=link center point, and P4=link center point. In this case, as shown in FIG. 10C, the center apparatus specifies the respective positions of P1, P2, P3 and P4, and next, connects the respective sections by a route search to specify the object road section.

Besides, as the road section reference data for specifying the object road, a road map is divided into tile-like parts, and identifiers attached to the respective ones, kilo posts provided on the road, road name, address, zip code and the like may be used.

Movement distance, movement time, exhaust gas information, wiper operation state, parking brake operation state and the like in addition to the speed, the power output, and the fuel consumption can be included in the measurement information.

### Second Embodiment

In a probe-car system of a second embodiment of the invention, when a on-board unit of a probe-car having passed through under an upstream side beacon passes along a previously determined road and reaches a downstream side beacon, only measurement information is uploaded to the downstream side beacon, and when passing along another road and reaching the downstream side beacon, swept path data and the measurement information are uploaded to the downstream side beacon. In order to enable the on-board unit itself to discriminate whether it has passed along the previously determined road, the upstream side beacon transmits the number of the downstream side beacon and the distance to the downstream side beacon to the on-board unit. When the on-board unit reaches the downstream side beacon, in the case where the travel distance is substantially coincident with the distance to the downstream side beacon transmitted from the upstream side beacon, the on-board unit discriminates that it has passed along the previously determined road, and when the travel distance is much different from the distance to the downstream side beacon transmitted from upstream side beacon, the on-board unit discriminates that it has not passed along the previously determined road.

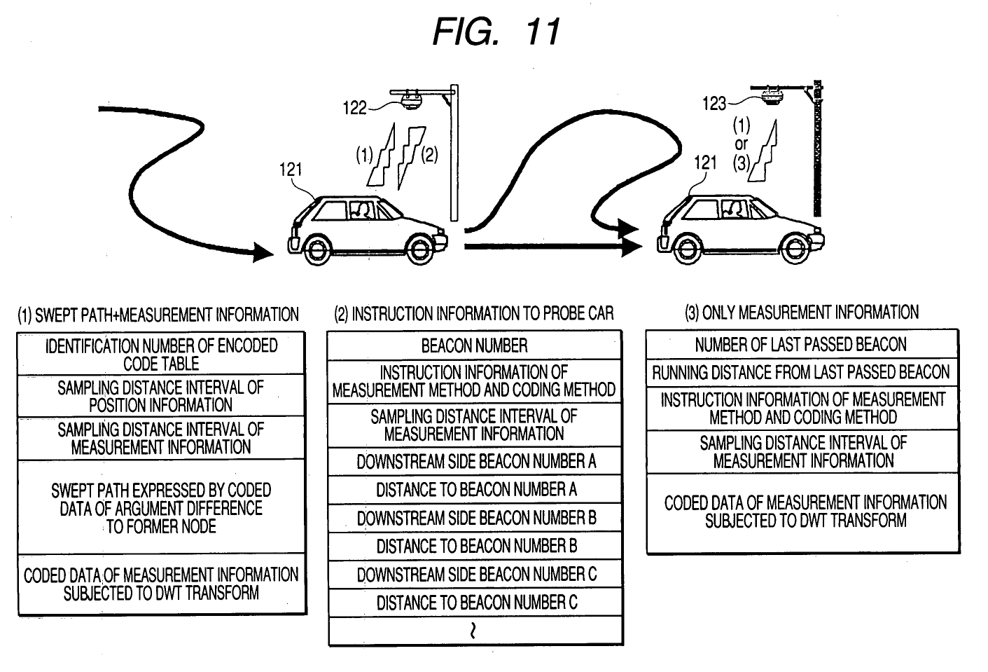

FIG. 11 exemplifies the data structure of data transmitted and received between the on-board unit and the beacon.

Data (1) “swept path+measurement information” is FCD information uploaded from the on-board unit to the downstream side beacon 123 when the probe-car 121 reaches the downstream side beacon 123 without passing along the previously determined road. This is the same as the FCD information transmitted from the on-board unit to the beacon 122 in the first embodiment (FIG. 1) when the probe-car 121 first passes through under the beacon 122, or passes through under the beacon 122 after the specified time has passed since it passed through under the last beacon (or after it runs the specified distance or more).

Data (2) “instruction information to probe-car” is instruction information transmitted from the downstream side beacon 122 to the on-board unit. This information includes information of the number of the downstream side beacon 123, and the distance to the beacon 123 in addition to the beacon number of the beacon 122, instruction information of measurement method and coding method, and sampling distance interval of measurement information.

Data (3) “only measurement information” is FCD information uploaded from the on-board unit to the downstream side beacon 123 when the probe-car 121 passes along the previously determined road and reaches the downstream side beacon 123. This is the same as the FCD information transmitted to the downstream side beacon 123 in the first embodiment (FIG. 1) when the probe-car 121 passes through under the downstream side beacon 123 within the specified time since it passed through under the upstream side beacon 122. Incidentally, in the case of “only measurement information”, the information of “travel distance from last passed beacon” may not be included.

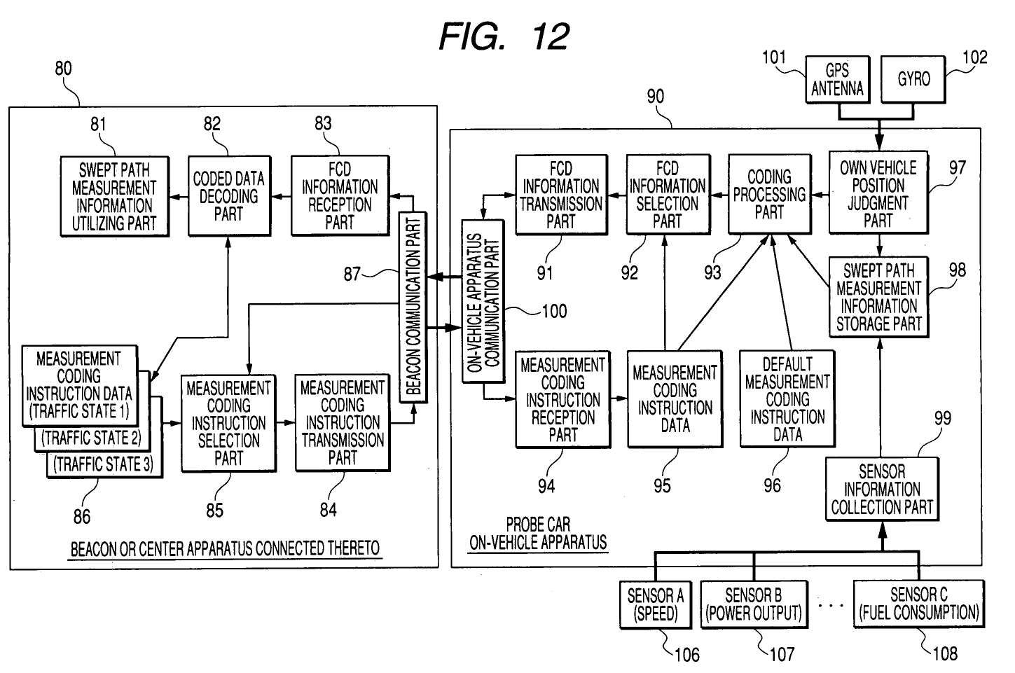

FIG. 12 shows a structure of this probe-car system. In this system, an FCD information selection part 92 of an on-board unit 90 selects FCD information to be uploaded on the basis of the information of distance to the downstream side beacon included in measurement coding instruction data 95. The other structure is identical to that of the first embodiment (FIG. 2).

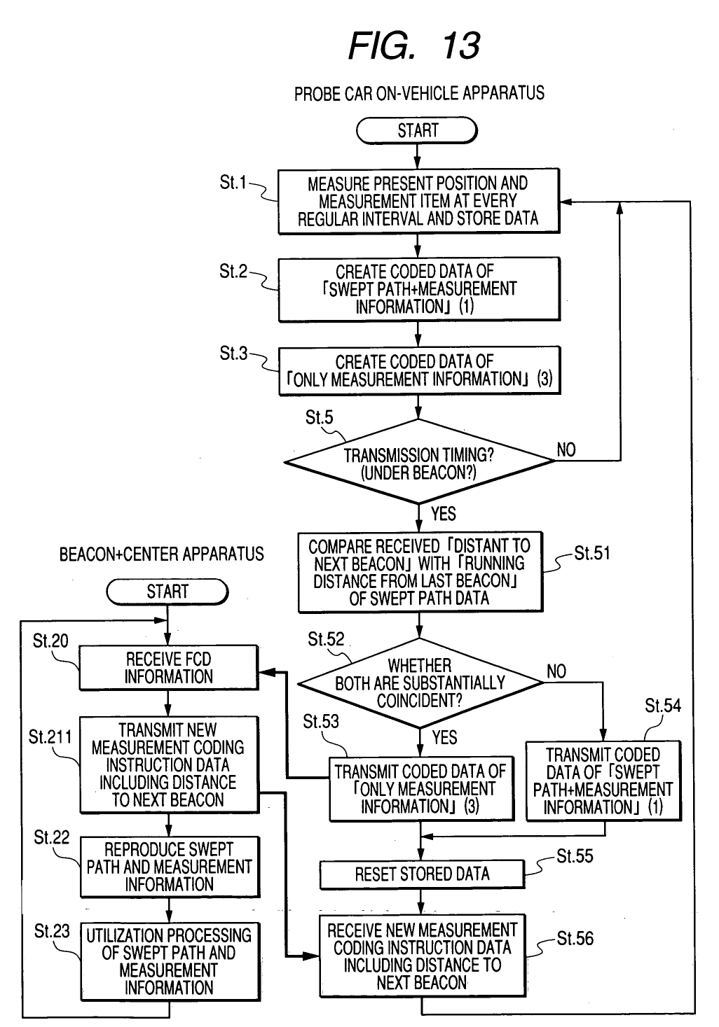

FIG. 13 shows a processing flow of this system. The processings of step 1 to step 3 are the same as the processings of the same steps of the processing flow (FIG. 3) of the first embodiment.

When the probe-car reaches the beacon, and an on-vehicle communication part 100 starts two-way communication with a beacon communication part 87 (step 5), the FCD information selection part 92 acquires information of the beacon number of the beacon through the on-vehicle communication part 100, refers to the measurement coding instruction data 95, reads information of distance to the beacon having the pertinent number, and compares this distance with the travel distance from the last passed beacon obtained at step 3 (step 51). In the case where both are coincident with each other (Yes at step 52), it is determined that “only measurement information” ((3) of FIG. 11) is the FCD information to be transmitted, and the FCD information transmission part 91 transmits the determined “only measurement information” to the beacon (step 53). In the case where both are much different from each other (No at step 52), it is determined that “swept path+measurement information” ((1) of FIG. 11) is the FCD information to be transmitted, and the FCD information transmission part 91 transmits the determined “swept path+measurement information” to the beacon (step 54). After transmitting the FCD information to the beacon, the on-board unit 90 resets the data stored in a swept path measurement storage part 98 (step 55).

When receiving the FCD information (step 20), the center apparatus 80 transmits new measurement and coding instruction data 86 selected by a measurement coding instruction selection part 85 to the on-board unit 90. As shown by (2) of FIG. 11, the measurement and coding instruction data 86 includes the information of the number of the next beacon and the distance to the beacon (step 211). The on-board unit 90 receives the new measurement and coding instruction data (step 56), and repeats the procedure from step 1.

In the case where “swept path+measurement information” ((1) of FIG. 11) is received, the center apparatus 80 refers to the pertinent measurement and coding instruction data, decodes the coded data, and reproduces the measurement information on the swept path. In the case where “only measurement information” ((3) of FIG. 11) is received, the center apparatus refers to the pertinent measurement and coding instruction data, decodes the coded speed data, and reproduces the speed information in which the installation route of the beacon is the swept path (step 22). The reproduced speed information is utilized for creation of traffic information and the like (step 23).

As stated above, in this system, even in the case where the probe-car runs while bypassing the installation route of beacons, it becomes possible for the center apparatus to utilize the measurement information measured by the on-board unit and the swept path information.

Although the judgment as to whether the probe-car bypasses the installation route of the beacons is made by the on-board unit itself, in the case where the information of “travel distance from last passed beacon” is made to be included in (1) “only measurement information”, the center apparatus can check the propriety of the judgment of the on-board unit.

### Third Embodiment

In a probe-car system of a third embodiment of the invention, similarly to the second embodiment, when an on-board unit of a probe-car having passed through under an upstream side beacon passes along a previously determined road and reaches a downstream side beacon, only measurement information is uploaded to the downstream side beacon, and when the on-board unit passes along another road and reaches the downstream side beacon, swept path data and measurement information are uploaded to the downstream side beacon.

In the system of the third embodiment, the upstream side beacon transmits a road network (road shape), which leads to the downstream side beacon, to the on-board unit, so that the on-board unit itself can discriminate whether it has passed along the previously determine road. The on-board unit compares the road shape with the swept path, and judges whether the route to the downstream side beacon is the previously determined road.

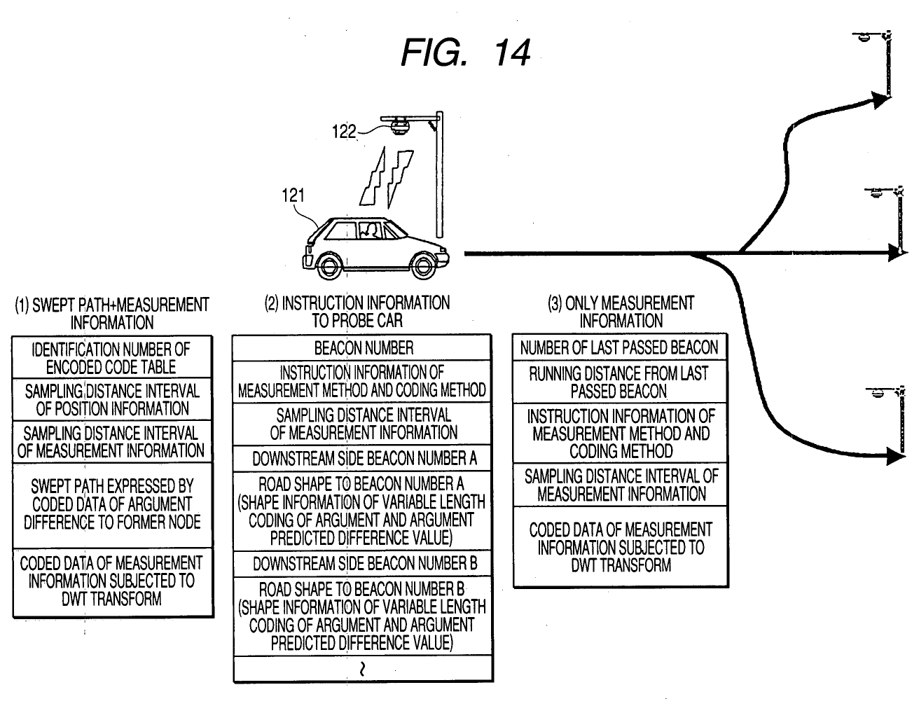

FIG. 14 exemplifies a data structure of data transmitted and received between the on-board unit and the beacon.

Data (1) “swept path+measurement information” is FCD information uploaded from the on-board unit to the downstream side beacon when the probe-car 121 reaches the downstream side beacon without passing along the previously determined road, and is the same as the FCD information ((1) “swept path+measurement information”) of the second embodiment (FIG. 11).

Data (2) “instruction information to probe-car” is instruction information transmitted from the downstream side beacon 122 to the on-board unit. This information includes the number of a downstream side beacon, and a data row composed of variable length coded data of argument predicted difference values expressing the road shape to the beacon, in addition to the beacon number of the beacon 122, instruction information of measurement method and coding method, and sampling distance interval of measurement information. The coded data of the road shape is created by the method described in the foregoing

<Creation of Running Locus Data>.

Data (3) “only measurement information” is FCD information uploaded from the on-board unit to the downstream side beacon when the probe-car 121 passes along the previously determined road and reaches the downstream side beacon 123, and is the same as the FCD information ((3) “only measurement information”) of the second embodiment (FIG. 11).

The structure of the probe-car system is the same as the second embodiment (FIG. 12).

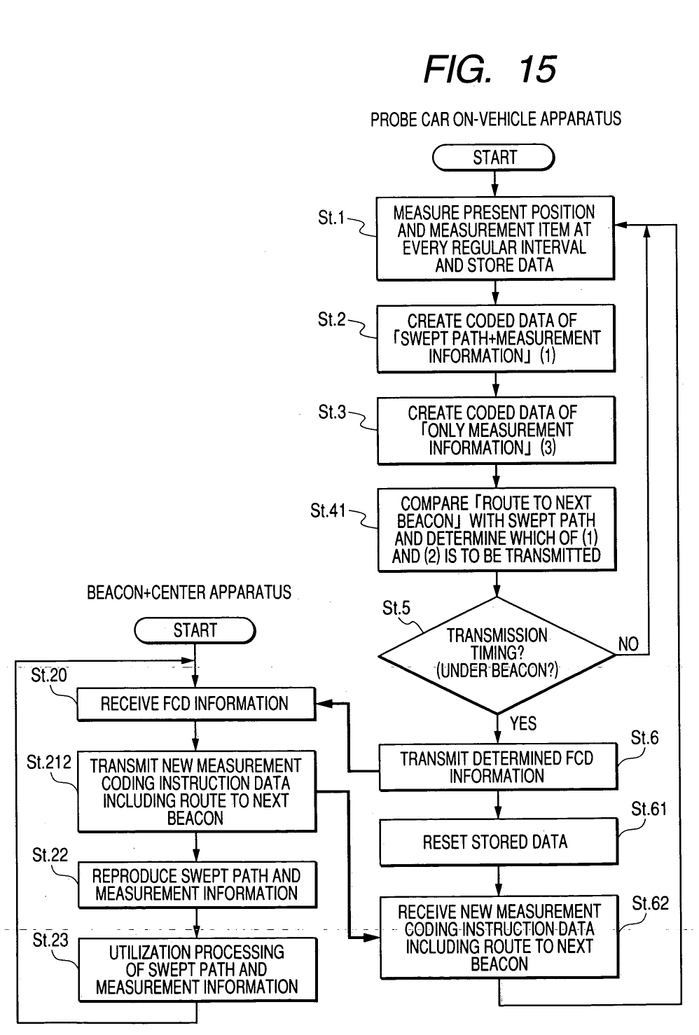

FIG. 15 shows a processing flow of this system. Processings of step 1 to step 3 are the same as the processings of the same steps in the processing flow (FIG. 3) of the first embodiment.

The FCD information selection part 92 of the on-board unit 90 refers to the measurement coding instruction data 95, and compares the road shape to the downstream side beacon included therein with the swept path by map matching or the like. When they are coincident with each other, it is determined that (3) “only measurement information” created at step 3 is to be transmitted as the FCD information, and when they are not coincident with each other, it is determined that (1) “swept path+measurement information” created at step 2 is to be transmitted as the FCD information (step 41). This operation is repeated until the transmission timing occurs.

When the probe-car reaches the beacon and the on-vehicle apparatus communication part 100 starts the two-way communication with the beacon communication part 87 (step 5), the FCD information transmission part 91 transmits the FCD information determined by the FCD information selection part 92 to the beacon (step 6). After transmitting the FCD information to the beacon, the on-board unit 90 resets the data stored in the swept path measurement information storage part 98 (step 61).

When receiving the FCD information (step 20), the center apparatus 80 transmits the new measurement and coding instruction data 86 selected by the measurement coding instruction selection part 85 to the on-board unit 90. As indicated by (2) of FIG. 14, the measurement and coding instruction data 86 includes the number of a next beacon and the information indicating the road shape to the beacon (step 212). The on-board unit 90 receives the new measurement and coding instruction data (step 62), and repeats the procedure from step 1.

The center apparatus 80 reproduces the swept path and measurement information and utilizes it. This processing is the same as steps 22 and 23 in the processing flow (FIG. 13) of the second embodiment.

As stated above, the on-board unit of this system travels while judging whether the swept path is coincident with the previously determined passage to the beacon. In the case where the on-board unit passes along the previously determined passage and reaches the beacon, it uploads only the measurement information to the beacon. In the case where the on-board unit reaches the beacon without passing along the previously determined passage, it uploads the measurement information and the swept path to the beacon.

In this system, it is possible to accurately discriminate whether the probe-car passes along the previously determined passage, and accordingly, even in the case where the probe-car passes along any route, the measurement information measured by the on-board unit can be effectively utilized.

As is apparent from the above description, in the probe-car system of the invention, the measurement information is effectively collected from the on-board unit by using the beacons, and can be effectively utilized.

Besides, the on-board unit of the invention can realize the probe-car system.

What is claimed is:

1. A probe-car system comprising:
an on-board unit of a probe-car;
a first beacon; and
a center apparatus,
wherein said on-boar unit uploads at least one of:
first information including measurement information measured while the probe-car is moving; and
second information including said measurement information and road section reference data indicating a measurement section of the measurement information,
to said first beacon, and
wherein said center apparatus collects the measurement information from the on-board unit of a probe-car through the beacon.

2. The probe-car system according to claim 1, further comprising:
a second beacon in upstream side, which the probe-car last passed,
wherein said on-board unit compares a travel distance or a driving time from said second beacon with a previously set threshold,
if the travel distance or the driving time exceeds the threshold, said on-board unit uploads the second information to the first beacon, and
if the travel distance or the driving time is not larger than the threshold, said on-board unit uploads the first information to the first beacon.

3. The probe-car system according to claim 2,
wherein said first information further includes the beacon number of said second beacon and the travel distance from said second beacon, and
wherein said center apparatus compares a road distance between said first beacon and said second beacon with the travel distance, and determines whether or not the measurement information in the first information is adopted.

4. The probe-car system according to claim 1, further comprising:
a third beacon in a downstream side,
wherein said on-board unit downloads a distance between said first beacon and said third beacon from said first beacon, and compares the downloaded distance with a travel distance to said third beacon,
if said downloaded distance is approximately same to said travel distance, said on-board unit uploads the first information to said first beacon, and
if said downloaded distance is not approximately same to said travel distance, said on-board unit uploads the second information to said first beacon.

5. The probe-car system according to claim 1, further comprising:
a third beacon in a downstream side,
wherein said on-board unit downloads road section reference data indicating a road section to a downstream side beacon from said first beacon, and compares the downloaded road section reference data with a swept path to said third beacon,
if the probe-car run along the road section indicated by the road section reference data, said on-board unit uploads said first information to the first beacon, and
if the probe-car run along a road section other than the road section indicated by the road section reference data, said on-board unit uploads said second information to said first beacon.

6. The probe-car system according to claim 1,
wherein said on-board unit uploads, as the road section reference data, coded data obtained by coding position information on a swept path at every regular distance, and
wherein said center apparatus decodes the coded data, restores the position information, and specifies the measurement section of the measurement information.

7. The probe-car system according to claim 5,
wherein said on-board unit downloads coded data obtained by coding position information on the road section at every regular distance, as the road section reference data indicating the road section to the third beacon, restores the position information by decoding said coded data, and compares the position information with the swept path.

8. The on-board unit of a probe-car comprising:
a communication unit for communicating with a beacon;
an own vehicle position judgment unit for detecting own vehicle position;
a sensor information collection unit for collecting measurement information of a sensor;
a storage unit for storing the measurement information collected by the sensor information collection unit and a swept path made of a set of the own vehicle position detected by the own vehicle position judgment unit;
a coding processing unit for transforming the measurement information and the swept path stored in the is storage unit into coded data;
an information transmission unit for transmitting the coded data of the one of a first information including said measurement information and a second information including said measurement information and the swept path, to the beacon, when passing through the beacon; and
an instruction information reception unit for receiving instruction information including instructions of a measurement method of the measurement information and a coding method of the coded data from the beacon.

9. The on-board unit of a probe-car according to claim 8,
wherein the information transmission unit compares a travel distance or a driving time from a last passed upstream side beacon with a previously set threshold,
if the travel distance or the driving time exceeds the threshold, transmits the second information, and
if the travel distance or the driving time is not larger than the threshold, transmits the first information.

10. The on-board unit of a probe-car according to claim 8,
wherein the instruction information reception unit receives, as the instruction information, instruction information including information of a distance to a downstream side beacon,
wherein the information transmission unit compares the distance included in the instruction information with a travel distance to the downstream side beacon,
if said received distance is approximately same to said travel distance, transmits said first information, and
if said received distance is not approximately same to said travel distance, transmits said second information.

11. The on-board unit of a probe-car according to claim 8,
wherein said instruction information reception unit receives, as the instruction information, instruction information including information indicating a road section shape to a downstream side beacon,
wherein the information transmission unit compares the road section shape to the downstream side beacon included in the instruction information with the swept path,
if said probe-car ran a road section indicated by the road section shape, transmits the first information, and
if said probe-car ran a road section other than the road section indicated by the road section shape, transmits the second information.
